(19) United States
(12) Patent Application Publication
(10) Pub. No.: US 2011/0049208 A1
(43) Pub. Date: Mar. 3, 2011

(54) Coupling Device for Connecting Bicycle Rack to Hitch Ball

(76) Inventor: Chiu-Kuei Wang, Taichung County (TW)

(21) Appl. No.: 12/634,612

(22) Filed: Dec. 9, 2009

(30) Foreign Application Priority Data
Aug. 28, 2009 (TW) 097132969

(51) Int. Cl. B60R 11/00

(52) U.S. Cl. 224/520

(57) ABSTRACT

A coupling device for connecting a bicycle rack to a hitch ball includes a casing and a pivotal frame which is pivotally connected to the casing and the hitch ball can be clamped within a spherical recess between the casing and the pivotal frame. A push plate is located in the casing and the pivotal frame includes a limiting member to which the push plate is in contact therewith. The push plate has an inclined surface so that the limiting member together with the pivotal frame are pushed toward the hitch ball by moving the push plate to further secure the connection of the hitch ball, the casing and the pivotal frame. The pivotal frame can be pivoted to allow the hitch ball to be removed from the spherical recess.

### BACKGROUND OF THE PRESENT INVENTION

1. Field of Invention

The present invention relates to a coupling device for securely connecting a bicycle rack to a hitch ball on a vehicle.

2. Description of Related Arts

A conventional coupling device for connecting a bicycle rack to a hitch ball includes a frame in which a recess is defined and the hitch ball is accommodated in the recess. A pressing member is connected to the top of the frame and extends through the frame so as to fix the hitch ball. Nevertheless, the hitch ball shakes within the recess of the frame and applies a significant force to the pressing member which is easily deformed and damaged. Once the pressing member cannot fix the hitch ball, the bicycle rack may be separated from the hitch ball and causes serious accident on the road.

The present invention intends to provide a coupling device which includes a spherical recess to accommodate the hitch ball and the pivotal frame can be pushed toward the hitch ball by moving a push plate so as to further secure the hitch ball.

### SUMMARY OF THE PRESENT INVENTION

An objective of the present invention is to provide a coupling device, which securely clamps the hitch ball so as to avoid separation of the bicycle rack and the hitch ball.

Another objective of the present invention is to provide a coupling device which includes a push plate with an inclined surface to which the limiting member is in contact therewith, when moving the push plate, the limiting member together with the pivotal frame are pushed toward the hitch ball to further clamp the hitch ball.

Yet another objective of the present invention is to provide a coupling device wherein a lock member is provided to be located beneath the two blocks to prevent the blocks and the pivotal frame from being pivoted.

Accordingly, in order to accomplish the above objectives, the present invention provides a coupling device for connecting a bicycle rack to a hitch ball, wherein the coupling device comprises a casing, wherein the casing has a first recess, a first side panel, and a second side panel, wherein the first and second side panels are connected to two sides of the casing. A connection frame is connected between the first and second side panels, so as to be connected with the bicycle rack. Two respective first holes are defined in the first and second side panels respectively and a pivot extends through the first holes of the first side panel, wherein a pivotal frame is provided between the side panels. The pivotal frame includes a second recess which is cooperated with the first recess in the casing to form a spherical recess to receive the hitch ball. Two blocks are located on two sides of the pivotal frame, wherein each two sides have a first pivot hole and a second pivot hole. A first pin extends through the first pivot holes of the two blocks and the two pivot lugs of the pivotal frame.

A limiting member is located between the two blocks, wherein a second pin is extended through the two second pivot holes and the limiting member. A lever is connected between the two blocks. By operation the lever, the pivotal frame is pivoted to open the spherical recess so that the hitch ball can be inserted into the spherical recess or removed from the spherical recess. The pivotal frame can be pushed to further clamp the hitch ball by adjusting the push plate.

The present invention will become more obvious from the following description when taken in connection with the accompanying drawings which show, for purposes of illustration only, a preferred embodiment in accordance with the present invention.

These and other objectives, features, and advantages of the present invention will become apparent from the following detailed description, the accompanying drawings, and the appended claims.

### BRIEF DESCRIPTION OF THE DRAWINGS

FIG. 1 is a perspective view of a coupling device according to a preferred embodiment of the present invention.

FIG. 2 is an exploded view of the coupling device according to the above preferred embodiment of the present invention.

FIG. 3 is another exploded view of the coupling device according to the above preferred embodiment of the present invention.

FIG. 4 is another perspective view of part the coupling device according to the above preferred embodiment of the present invention.

FIG. 5 is a partially cross sectional view of the coupling device according to the above preferred embodiment of the present invention.

FIG. 6 is another partially cross sectional view of the coupling device according to the above preferred embodiment of the present invention, illustrating the lever being pivotally connected to the pivotal frame and to open the spherical recess of the coupling device of the present invention.

FIG. 7 is still another partially cross sectional view of the coupling device according to the above preferred embodiment of the present invention, illustrating the lever being pivotally moved back to original position to clamp the hitch ball in the spherical recess of the coupling device.

FIG. 8 shows that the hitch ball is clamped between the first and second recess of the casing and the pivotal frame according to the above preferred embodiment of the present invention.

FIG. 9 shows that the push plate is moved to push the pivotal frame to move toward the hitch ball according to the above preferred embodiment of the present invention.

FIG. 10 shows that the lock member is connected to the second side panel of the coupling device of the present invention.

FIG. 11 shows that the latch of the lock member is rotated by using a key to connect the lock member to the second side panel according to the above preferred embodiment of the present invention.

FIG. 12A shows the bicycle rack is connected to the clamping device of the present invention according to the above preferred embodiment of the present invention.

FIG. 12B shows another bicycle rack is connected to the clamping device of the present invention according to the above preferred embodiment of the present invention.

FIG. 13 shows another embodiment of the clamping device of the present invention according to the above preferred embodiment of the present invention.

FIG. 14 is another partially cross sectional view to show the clamping device of the present invention in FIG. 13.

FIG. 15 shows that the lever of the clamping device of the present invention in FIG. 13 is pivoted.

FIG. 16 shows a bicycle rack is connected with the clamping device of the present invention in FIG. 13.

FIG. 17 shows a perspective view of the clamping device of the present invention in FIG. 13, which is connected with the bicycle rack.

FIG. 18 shows that the bicycle rack connected to the clamping device of the present invention in FIG. 13 is in its folded status.

FIG. 19 shows that the bicycle rack connected to the clamping device of the present invention in FIG. 13 is tilted.

### DETAILED DESCRIPTION OF THE PREFERRED EMBODIMENT

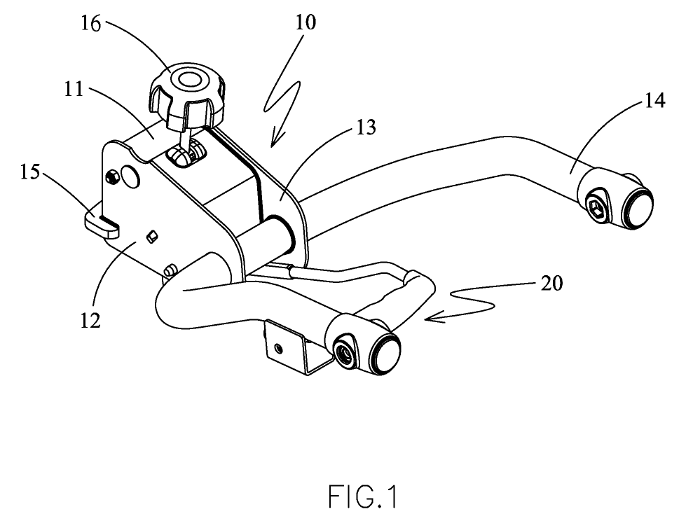

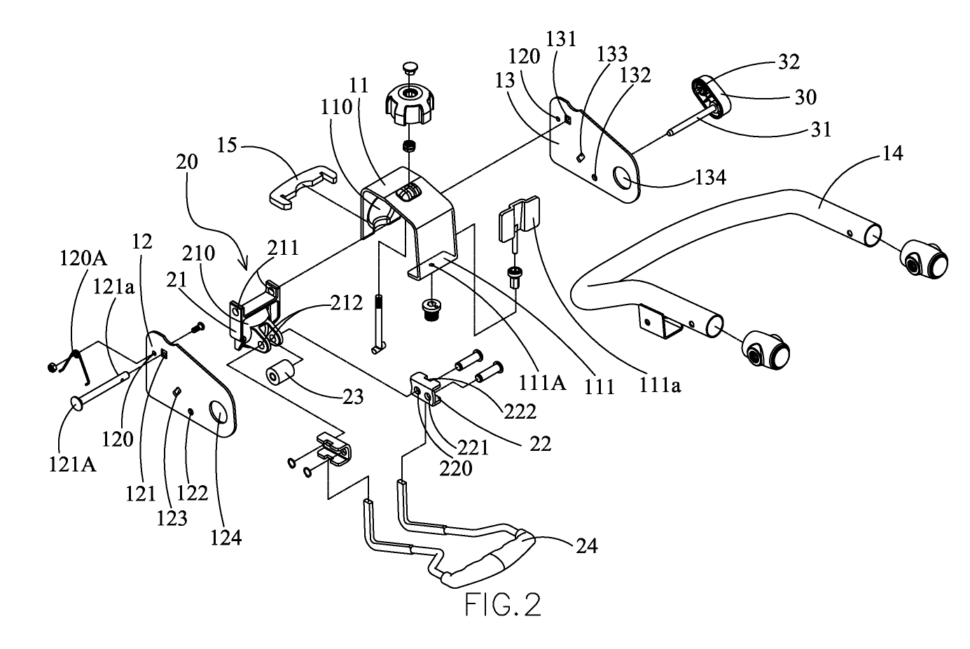

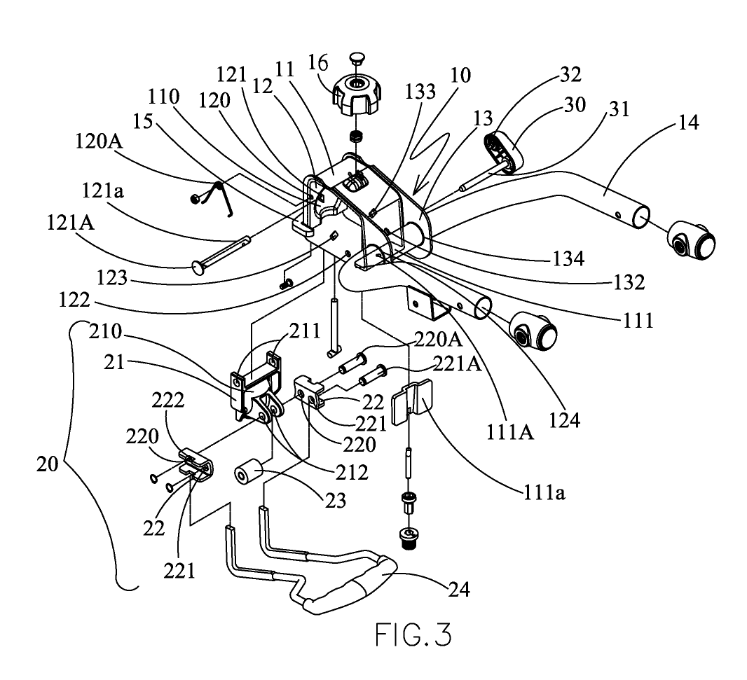

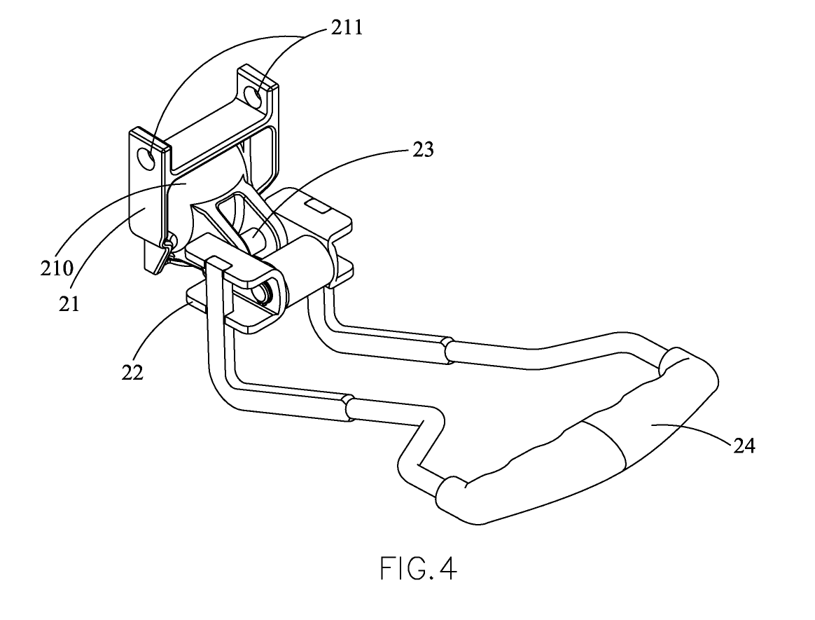

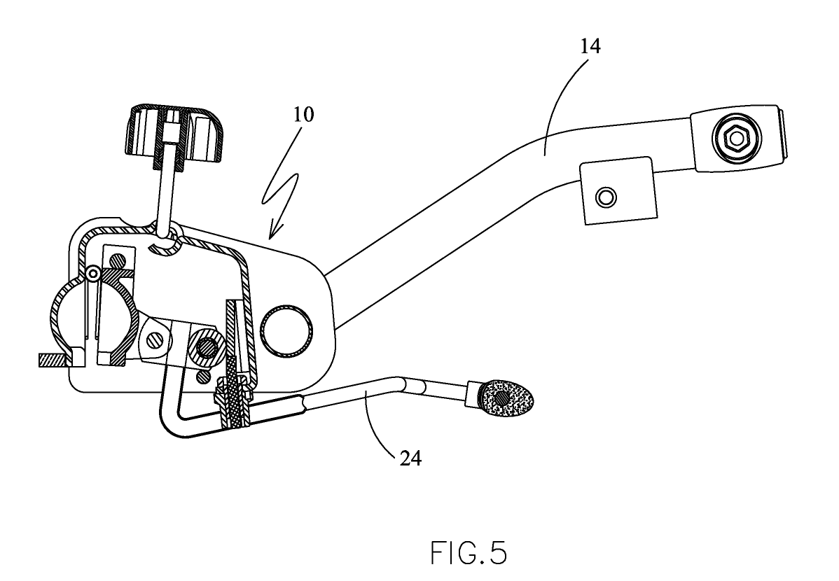

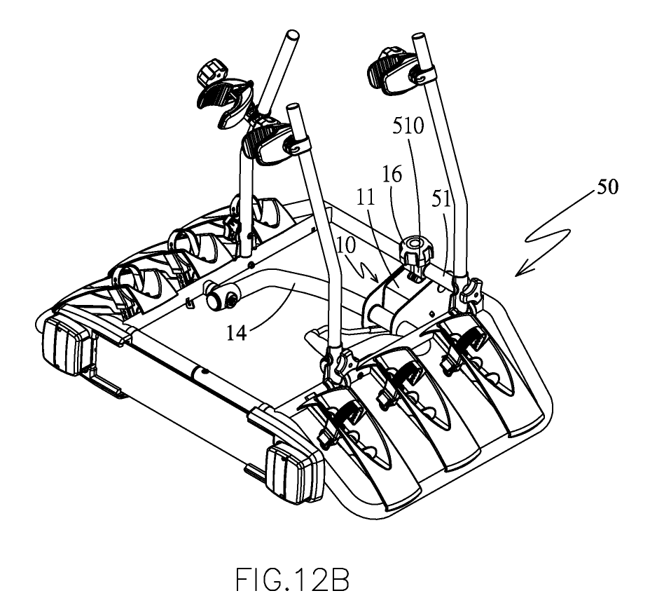

Referring to FIGS. 1 to 5, the coupling device for connecting a bicycle rack 50 to a hitch ball 40 of the present invention comprises a coupling unit 10 which comprises a casing 11, a first recess 110 provided at a front end of the casing 11, a bottom plate 111a extended from a rear end toward the front end of the casing 11, and a through hole 111A provided at the bottom plate 111a. A first side panel 12 and a second side panel 13 are provided for connecting to two sides of the casing 11. Two respective first holes 121, 131 are provided at a first side panel 12 and a second side panel 12 respectively. The second side panel 12 further comprise a pivot 121A extended through the first hole 121 of the first side panel 12, wherein distal end of the pivot 121A has two flat surfaces 121a engaged with the other first hole 131 at the second side panel 13. Each of the first and second side panels 12, 13 further has a fourth hole 124/134 and a connection frame 14 extending through the fourth holes 124, 134 of the first and second side panels 12, 13. The connection frame 14 is connected to the bicycle rack 50 as shown in FIG. 12A.

A pivotal unit 20 has a pivotal frame 21, a plurality of blocks 22, which is preferably embodied as two blocks 22, a limiting member 23 and a lever 24, wherein the pivotal frame 21 comprises a second recess 210, which is cooperated with the first recess 110 of the casing 11 to form a spherical recess, so as to clamp the hitch ball 40 in the spherical recess. The pivotal frame 21 further comprises two first pivotal connecting portion 211 extendedly provided at a top of the pivotal frame 21 and two second pivotal connecting portion 212 extendedly provided at a rear side of the pivotal frame 21. The pivot 121A is extended through the two first pivotal connecting portions 211 to pivotally connect the pivotal frame 21 to the casing 11. The two blocks 22 are located at two sides of the pivotal frame 21 and each of the blocks has a first pivot hole 220 and a second pivot hole 221. A first pin 220A is further provided, which is extended through the first pivot holes 220 of the two blocks 22 and the second pivotal connecting portions 212 of the pivotal frame 21. The limiting member 23 is located between the two blocks 22 and a second pin 221A, which is extended through the two second pivot holes 221 and the limiting member 23. Each of the two blocks 22 further has a connection part 222, wherein two ends of the connection frame 14 are engaged with the connection parts 222 of the first and second blocks 22.

The first side panel 12 has an engaging hole 120 and the a torsion spring 120A connected to the engaging hole 120 via a bolt. A first leg of the torsion spring 120A is contacting against an inner side of the casing 11 and a second leg of the torsion spring 120A is contacting an inner side of the front end of the pivotal frame 21.

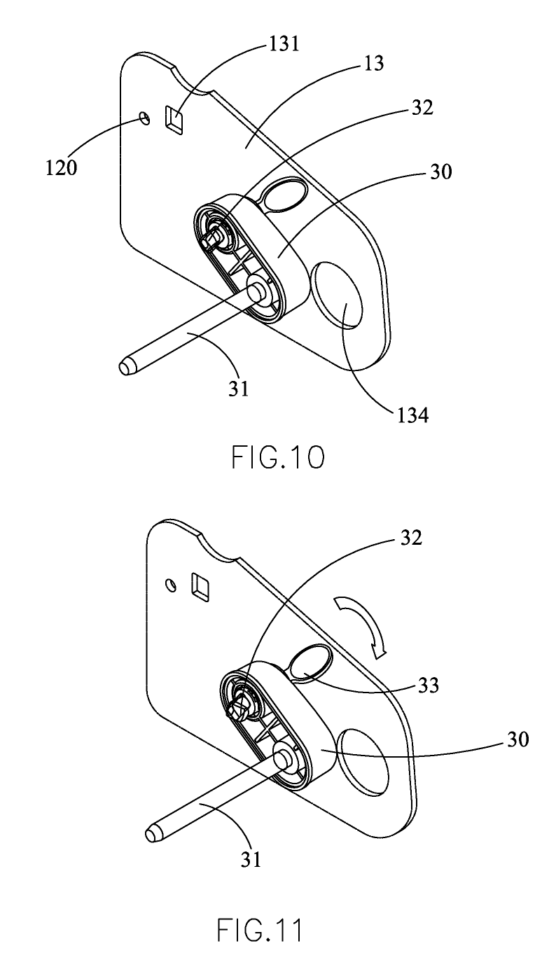

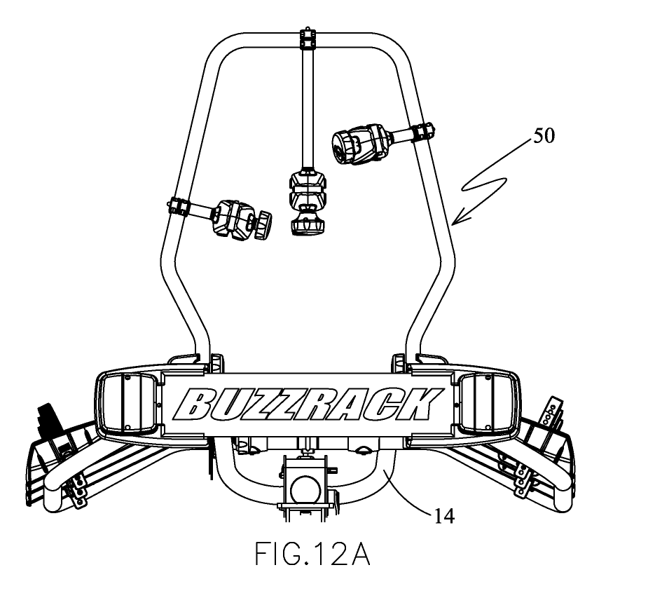

Each of the first and second side panels 12, 13 has a second hole 122/132 and a third hole 123/133. A lock member 30 has a lock shank 31 and a latch 32 extending. The lock shank 31 is extended through the second hole 132 of the second side panel 13, and the latch 32 is engaged with the third hole 133 at the second side panel 13. A key 33 having a shape geometrically matching the shape of an inserting hole at the lock shank 31 as shown in FIGS. 10 and 11 may further optionally provided for rotating the latch 32 to lock the lock member 30 at the second side panel 13, so as to fix the lock shank 31 at desired position. A distal end of the lock shank 31 is engaged with the second hole 122 of the first side panel 12. The lock shank 31 is in contact with undersides of the two blocks 22. The user can use a key 33 to rotate the latch to securely connect the lock member 30 to the second side panel 13. It is worth mentioning that the key 33 is provided as an example for actuating the lock member 30 to engage and disengage with the coupling unit 10. The lock member 30 may be fixedly locked via a code locker, electrical sensor, or any other mechanical or electrical methods to secure the lock member 30 with the coupling unit 10.

A push plate 111a is located on the bottom board 111 by extending a shank on the push plate 111a through the through hole 111A. The push plate 111a includes an inclined surface which pushes the limiting member 23.

It is noted that the lock member 30 can also be connected to the first side panel 12, wherein the lock shank 31 is extended through the second hole 122 of the first side panel 12 and the latch 32 is engaged with the third hole 123 in the first side panel 12. A distal end of the lock shank 31 is engaged with the second hole 132 of the second side panel 13. The lock shank 31 is in contact with undersides of the two blocks 22. A restriction member 15 is connected to the front end of the casing 11 and includes two side arms, which are located on two sides of the casing 11.

A fixing member 16 is extended through a top of the casing 11 and located between the first and second side panels 12, 13. The fixing member 16 is provided to fix a transverse bar 51 of the bicycle rack 50, as shown in FIG. 12B.

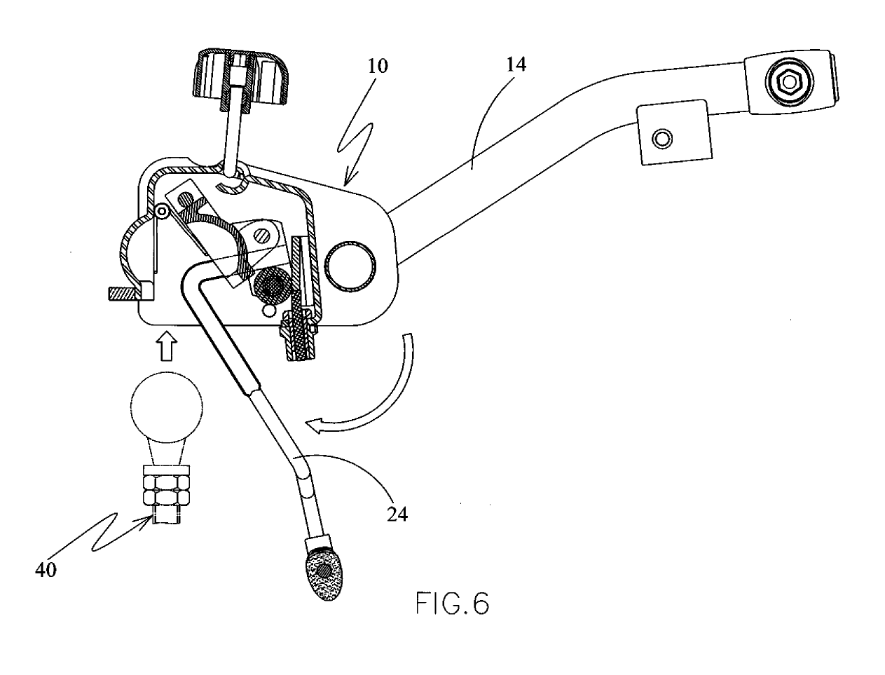

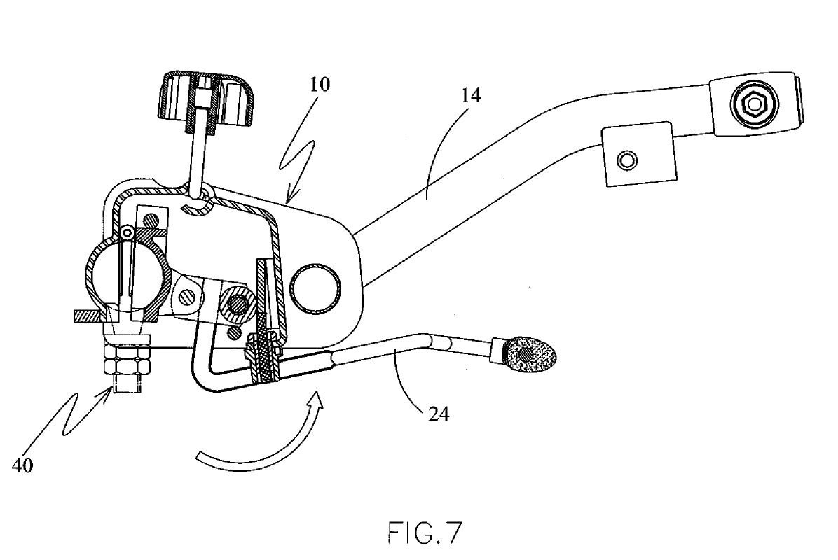

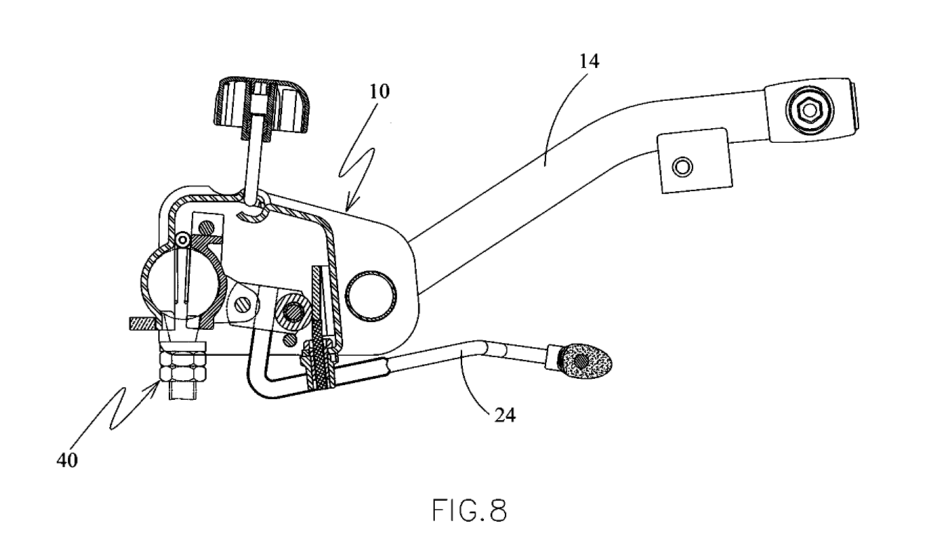

As shown in FIG. 6, when pivoting the lever 24 downwardly, the pivotal frame 21 is pivoted away from the front end of the casing 11, so as to open the spherical recess. Thus, the hitch ball 40 can be easily inserted into the spherical recess or removed from the spherical recess. The lever 24 is then pivoted back to its original position to clamp the hitch ball 40 in the spherical recess as shown in FIGS. 7 and 8.

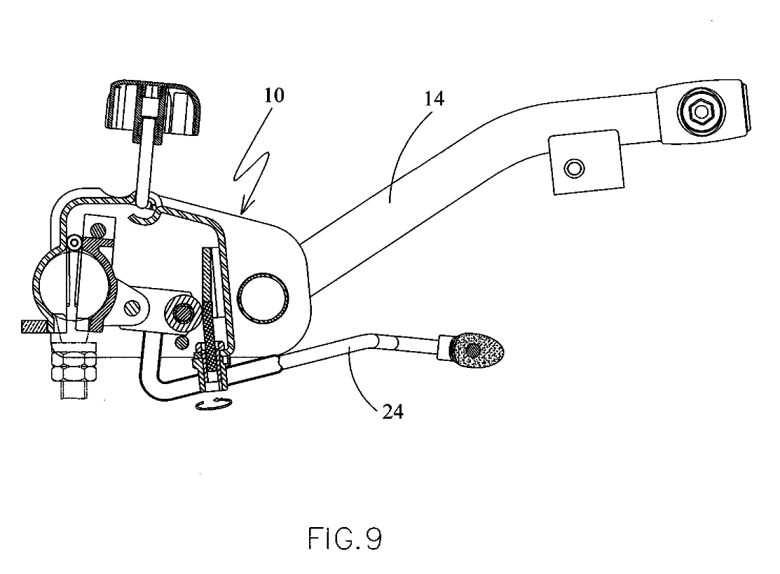

FIG. 9 shows that the push plate 111a is able to be moved upwardly by rotating the knob connecting with the shank of the push plate 111a, so that the inclined surface of the push plate 111a is moved to push the limiting member 23 together with the pivotal frame 21 toward the hitch ball 40, which is then further securely clamped.

As shown in FIGS. 12A and 12B, the fixing member 16 is cooperated with a U-shaped member 510 which is hooked to the transverse bar 51 of the bicycle rack 50 and the fixing member 16 securely connected to the U-shaped member 510 and the transverse bar 51. The two ends of the connection frame 14 are connected to the two side rails of the bicycle rack 50.

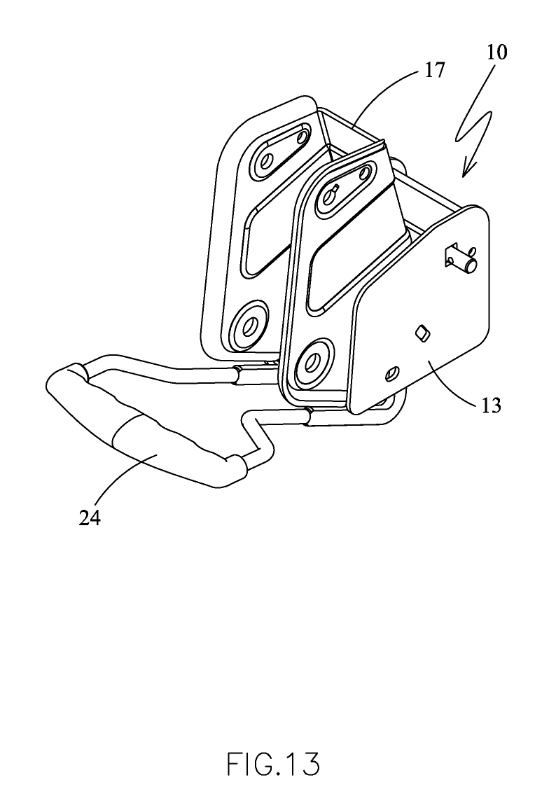

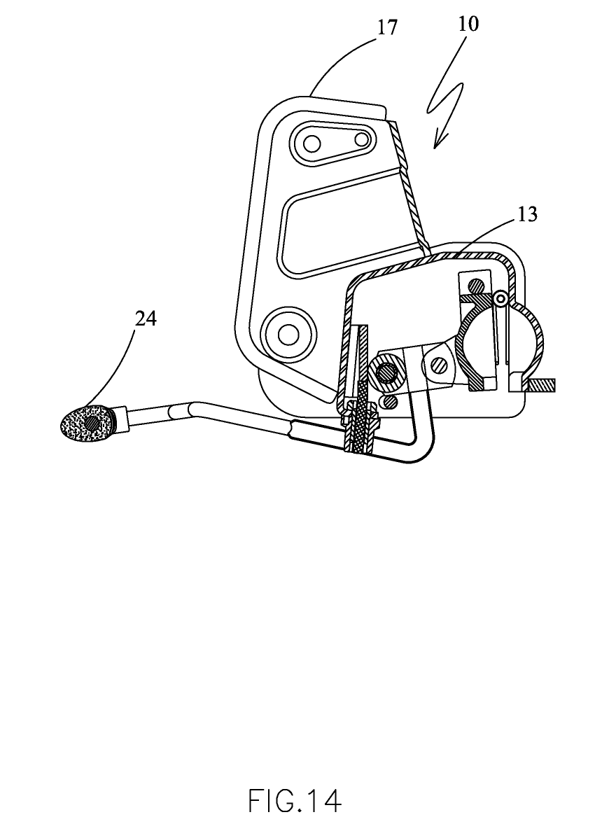

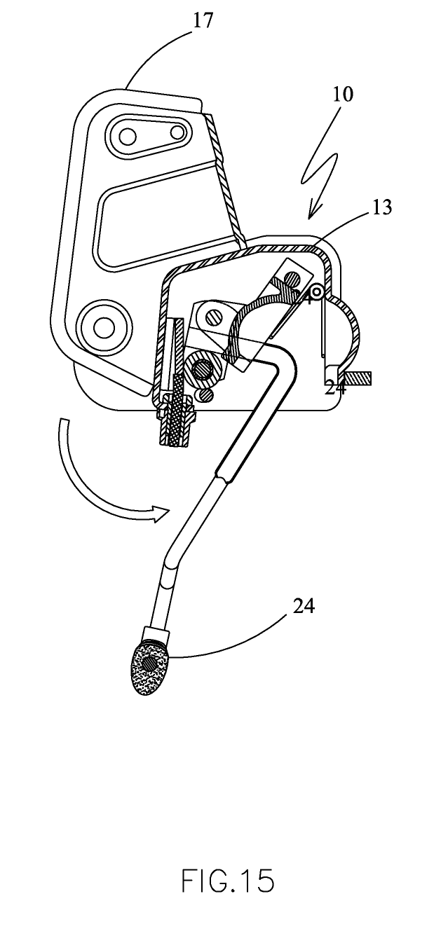

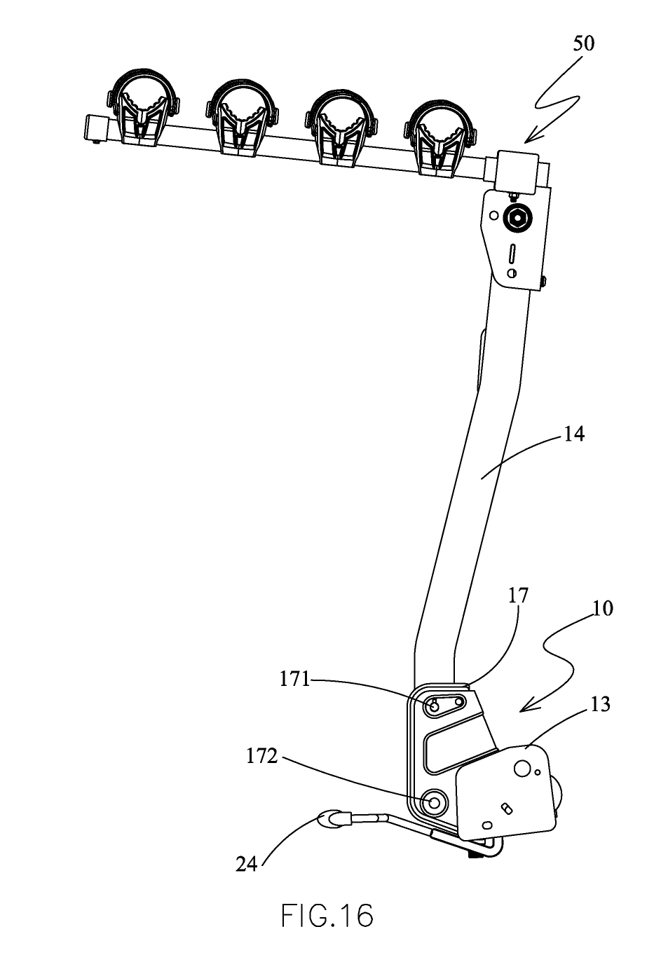

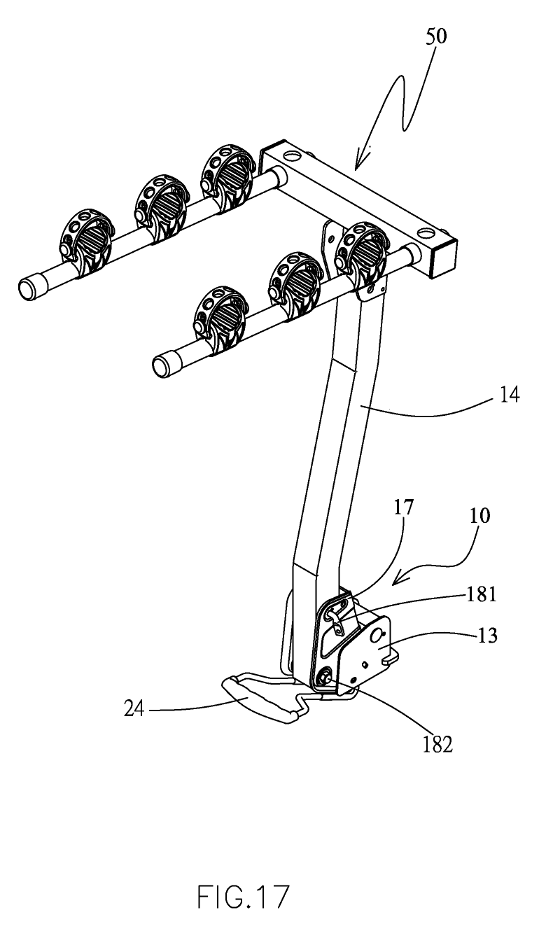

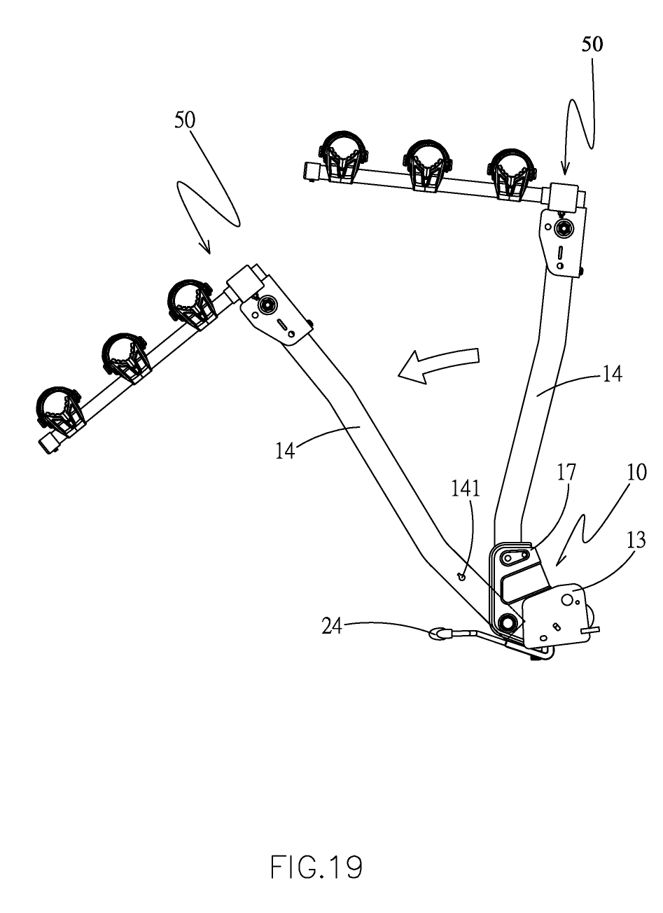

FIGS. 13 to 16 show another embodiment of the clamping device of the present invention, wherein the first and second side panels 12, 13 do not have the fourth holes 124, 134 and another type of the fixing member 17 is located between the first and second side panels 12, 13. The fixing member 17 includes two sidewalls. The connection frame 14 is pivotably connected between the two side walls of the fixing member 17 in the coupling unit 10 by extending a bolt 182 through the hole 172 at the two side walls of the fixing member 17. Each of the two sidewalls further includes a positioning hole 171 and one pin 181 extended through the positioning hole 171 and a pinhole 142 (FIG. 19) in the lower end of the connection frame 14 to position the connection frame 14. The two positioning holes 171 are located on a substantially horizontal direction, as shown in FIGS. 16 and 17.

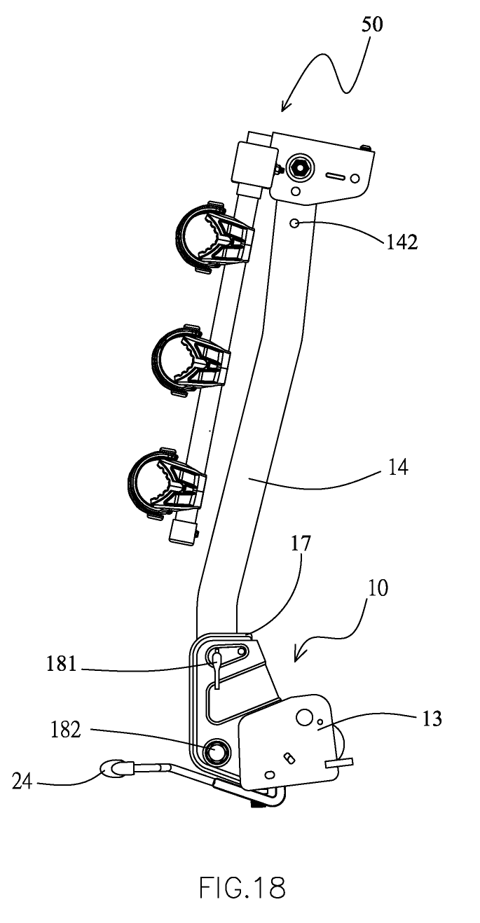

FIGS. 18 to 19 show that the bicycle rack 50 is able to be folded parallely to the connection frame 14 as shown in FIG. 18 by removing a pin from another pinhole 142 (FIG. 18) located at a top end of the connection frame 14 and the pivotal part of the bicycle rack 50, so as to reduce the space at the rear end of the vehicle, which is not shown in Figs. The FIG. 19 shows that the connection frame 14 can be tilted relatively to the rear end of the vehicle to allow the hatch door of the vehicle to be opened by removing the pin 181 from the positioning hole 171, as shown in FIG. 19.

The present invention provides a firm and stable clamping force to the hitch ball 40 whose reaction force can be shared by the casing 11 and the pivotal frame 21, so that the connection between the hitch ball 40 and the coupling device is stable.

While we have shown and described the embodiments in accordance with the present invention, it should be clear to those skilled in the art that further embodiments may be made without departing from the scope of the present invention.

One skilled in the art will understand that the embodiment of the present invention as shown in the drawings and described above is exemplary only and not intended to be limiting.

It will thus be seen that the objects of the present invention have been fully and effectively accomplished. The embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A coupling device comprising:
a coupling unit, which comprises a casing, a first recess provided at a front end of the casing, a first side panel and a second side panel connected to two sides of said casing respectively, two respective first holes provided at said first and second side panels respectively, a pivot extending through said first hole of said first side panel and a distal end of said pivot engaged with the other said first hole in said second side panel, and a connection frame connected between said first and second side, which is provided for connecting with a bicycle rack, and
a pivotal unit, which comprises a pivotal frame, two blocks, a limiting member, and a lever, wherein said pivotal frame comprises a second recess, two first pivotal connecting portions extending from a top of said pivotal frame and two second pivotal connection portions extending from a rear side of said pivotal frame, wherein said pivot is extending through said two first pivotal connecting portions to pivotally connect said pivotal frame to said casing, wherein said second recess is cooperated with said first recess within said casing to form a spherical recess, which is adapted to receive a hitch ball therein, said two blocks located at two sides of said pivotal frame, wherein each of said blocks has a first pivot hole, a second pivot hole, and a first pin extending through said first pivot holes of said two blocks and said second pivotal connecting portions of said pivotal frame, wherein said limiting member is located between said two blocks, wherein a second pin is extending through said two second pivot holes and said limiting member, wherein said lever is provided for connecting said two blocks at a position therebetween.

2. The coupling device as claimed in claim 1, wherein said casing further comprises a bottom board, wherein a through hole is provided at said bottom board, wherein a push plate is connected to said bottom board by a shank extending through said through hole, wherein said push plate further comprises an inclined surface for pushing said limiting member.

3. The coupling device as claimed in claim 1, wherein said first side panel further comprises an engaging hole, and a torsion spring connected to said engaging hole by a bolt, wherein a first leg of said torsion spring is contacting against an inner side of said casing and a second leg of said torsion spring is contacting an inner side of said front end of said pivotal frame.

4. The coupling device as claimed in claim 1, wherein each of said first and second side panels has a second hole and a third hole provided thereat, wherein said coupling device further comprises a lock member, which comprises a lock shank and a latch, wherein said lock shank is extended through said second hole of said second side panel, wherein said latch is engaged with said third hole at said second side panel, wherein a distal end of said lock shank is engaged with said second hole of said first side panel, wherein said lock shank is in contact with undersides of said two blocks.

5. The coupling device as claimed in claim 1, wherein each of said first and second side panels has a second hole and a third hole provided thereat, wherein said coupling device further comprises a lock member, which comprises a lock shank and a latch, wherein said lock shank is extended through said second hole of said second side panel, wherein said latch is engaged with said third hole at said second side panel, wherein a distal end of said lock shank is engaged with said second hole of said first side panel, wherein said lock shank is in contact with undersides of said two blocks.

6. The coupling device as claimed in claim 1, further comprises a restriction member connected to said front end of said casing, wherein said restriction member comprises two side arms, which are located at two sides of said casing.

7. The coupling device as claimed in claim 1, wherein each of said first and second side panels further has a fourth hole, wherein said connection frame is extended through said fourth holes of said first and second side panels.

8. The coupling device as claimed in claim 1, further comprises a fixing member extended through a top of said casing at a position between said first and second side panels, wherein said fixing member is provided for connecting to a transverse bar of said bicycle rack.

9. The coupling device as claimed in claim 1, wherein each of said two blocks has a connection part, wherein two ends of said connection frame are engaged with said two connection parts of said first and second blocks.
